(19) United States
(12) Patent Application Publication
(10) Pub. No.: US 2014/0175200 A1
(43) Pub. Date: Jun. 26, 2014

(54) SOUP MAKER WITH BLENDING FUNCTION

(71) Applicant: Kuan-Chih LIN, TAINAN (TW)

(72) Inventor: Kuan-Chih LIN, TAINAN (TW)

(21) Appl. No.: 13/726,562

(22) Filed: Dec. 25, 2012

(51) Int. Cl. A47J 43/07

(52) U.S. Cl. CPC A47J 43/0716
USPC 241/65

(57) ABSTRACT

A soup maker with blending function is composed of a container and a chassis. The container has a container base at the bottom, a thermal surface formed at the outer bottom for being attached with an annular electrothermal plate deposited in the container base. The electrothermal plate possesses a central hole bored in the center, plural positioning bars and plural through holes and a connecting terminal located at the bottom. The chassis has a groove used to accommodate a driving device and a thermal detector, and a control panel disposed at one side. With operation of the control panel, the driving device can drive a blending blade to whirl to smash vegetables and the electrothermal plate can be electrified to thermally conduct the thermal surface, so the vegetables can be blended and heated with a required temperature, speed and time.

### BACKGROUND OF THE INVENTION

1. Field of the Invention

This invention relates to a soup maker with blending function, particularly to one provided with a thermal apparatus. The soup maker with blending function is composed of a container and a chassis. The container is provided with a container base located at the bottom, a thermal surface formed at the outer bottom for being attached with an annular electrothermal plate deposited in the container base. The electrothermal plate possesses a central hole bored in the center, plural positioning bars and plural through holes and a connecting terminal located at the bottom. The chassis is provided with a groove used to accommodate a driving device and a thermal detector, and a control panel disposed at one side. With operation of the control panel, the driving device can drive a blending blade to whirl to smash vegetables and the electrothermal plate can be electrified to thermally conduct the thermal surface, so the vegetables can be blended and heated with a required temperature, speed and time.

2. Description of the Prior Art

Commonly, a conventional soup maker with blending function is composed of a jar and a chassis. The jar is provided with a lid on the top, a blending blade and a rotator installed at the bottom, and a handle located at one side. The chassis is provided with a chamber formed in the upper portion for installing a driving device, and a control panel disposed at one side. However the control panel can only command basic operation, unable to make vegetables being blended and heated with a required temperature, time and speed.

### SUMMARY OF THE INVENTION

The object of this invention is to offer a blender able to make vegetables being blended and heated in a container with a required temperature, speed and time.

The main characteristic is that the container has a thermal surface formed at the outer bottom for being attached with an annular electrothermal plate deposited in a container base. The electrothermal plate is provided with a central hole bored in the center, plural positioning bars and plural through holes and a connecting terminal located at the bottom.

### BRIEF DESCRIPTION OF DRAWINGS

This invention is better understood by referring to the accompanying drawings, wherein:

FIG. 1 is a partial exploded perspective view of a preferred embodiment of a soup maker with blending function in the present invention;

FIG. 2 is an exploded perspective view of the preferred embodiment of a soup maker with blending function in the present invention; and

FIG. 3 is a schematic illustration of the preferred embodiment of a soup maker with blending function in the present invention, showing it being operated.

### DETAILED DESCRIPTION OF THE PREFERRED EMBODIMENT

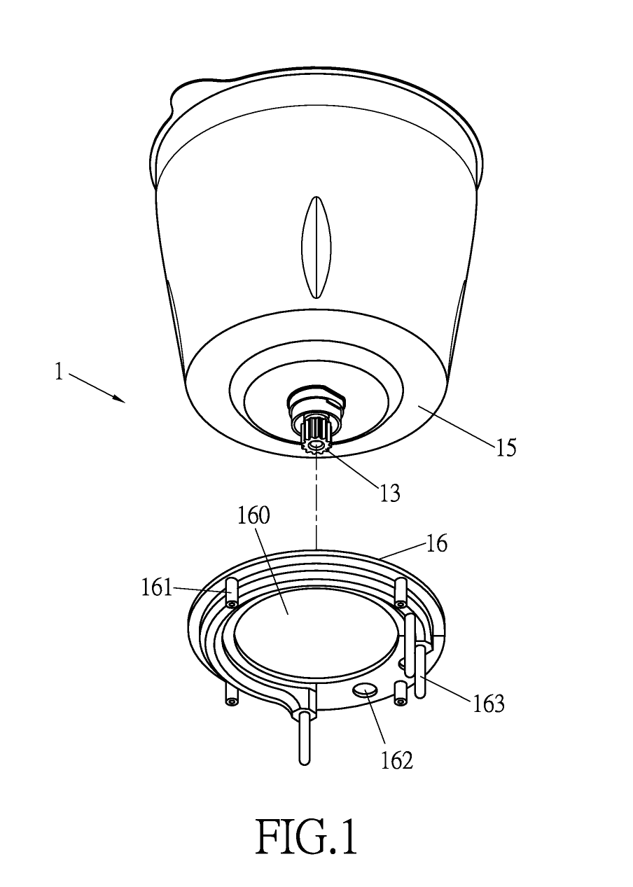

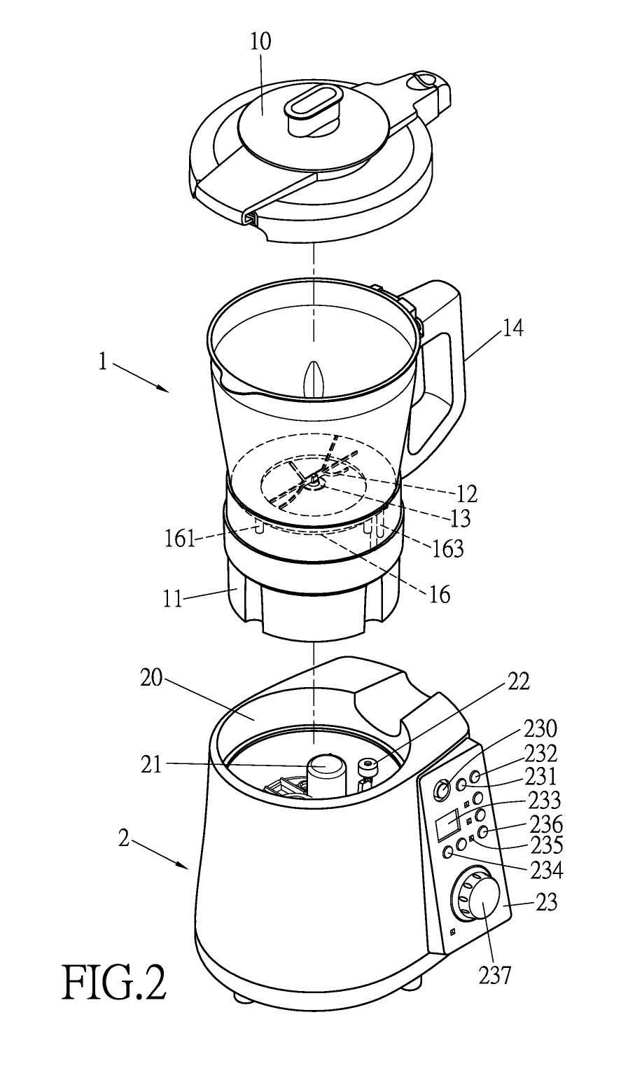

As shown in FIGS. 1 and 2, the preferred embodiment of a soup maker with blending function in the present invention is composed of a container 1 and a chassis 2.

The container 1 is made of metal, provided with a lid 10 on the top, a container base 11 formed at the bottom, a blending blade 12 and a rotating device 13 installed at the inner bottom, and a grip 14 located at one side. Furthermore, the container 1 has a thermal surface 15 formed at the outer bottom for being attached with an annular electrothermal plate 16 deposited in the container base 11. The electrothermal plate 16 is further provided with a through hole 160 bored in the center, plural positioning bars 161 and plural through holes 162 and a connecting terminal 163 located at the bottom.

A chassis 2 is deposited with the container base 11 of the container 1, provided with a groove 20 formed in the upper portion for accommodating a driving device 21 and a thermal detector 22, and a control panel 23 disposed at one side to electrically connect with the connecting terminal 163 of the electrothermal plate 16. The control panel 23 is further provided with a power switch 230, a low-speed button 231, a jog button 232, a display screen 233, a timer with an adjusting button 234, plural LED lights 235, a temperature adjuster 236 and a speed switch 237.

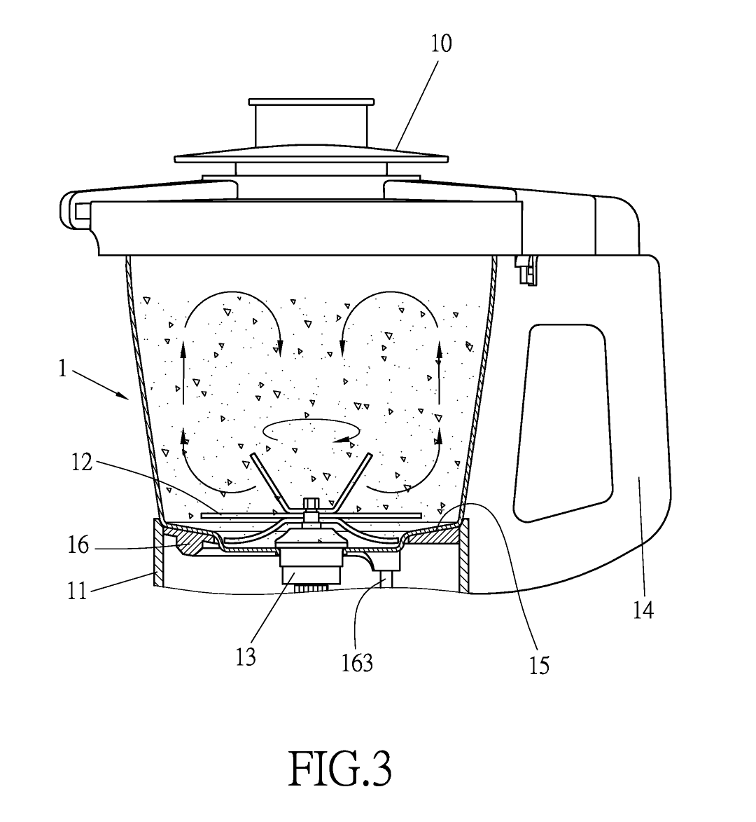

As shown in FIGS. 2 and 3, the assembly of the soup maker with blending function can be easily done as long as the container base 11 of the container 1 is laid in the groove 20 of the chassis 2, with the connecting terminal 163 of the electrothermal plate 16 electrically connected with the control panel 23 of the chassis 2. In using, by means of the display screen 233 and the LED lights 235, the low-speed button 231, the jog button 232, the timer with an adjusting button 234, the temperature adjuster 236 and the speed switch 237 can be adjusted as requirements when the power switch 230 is turned on, so as to drive the rotating device 13 and the blending blade 12 to smash vegetables in the container 1 as an expected speed and time. Meanwhile, with the electrothermal plate 16 electrified, the thermal surface 15 can be thermally conducted so that the vegetables can be blended and heated in the container 1 with a required temperature, time and speed.

While the preferred embodiment of the invention has been described above, it will be recognized and understood that various modifications may be made therein and the appended claims are intended to cover all such modifications that may fall within the spirit and scope of the invention.

What is claimed is:

1. A soup maker with blending function comprising:
a container provided with a lid on a top and a container base formed at a bottom, a blending blade and a rotating device installed at an inner bottom of said container, a grip located at one side of said container;
a chassis to be deposited with said container base of said container and provided with a groove formed in an upper portion for accommodating a driving device and a thermal detector, and a control panel disposed at one side of said chassis; and
said container characterized by having a thermal surface formed at an outer bottom for being attached with an annular electrothermal plate deposited in said container base, said electrothermal plate further provided with a central hole bored in a center, plural positioning bars and plural through holes and a connecting terminal located at a bottom of said electrothermal plate.

2. The soup maker with blending function as claimed in claim 1, wherein said container is made of metal.

3. The soup maker with blending function as claimed in claim 1, wherein said connecting terminal of said electrothermal plate is electrically connected with said control panel of said chassis.
